(19) United States
(12) Patent Application Publication
(10) Pub. No.: US 2010/0101552 A1
(43) Pub. Date: Apr. 29, 2010

(54) STONE CUTTING APPARATUS AND METHOD

(75) Inventors: John Tesh, Greensboro, NC (US); Ronnie McClain, Swansboro, NC (US); Edmar DeMoirais, Summerfield, NC (US); Sebastiao DeMorais, Greensboro, NC (US)

Correspondence Address: HAHN LOESER & PARKS, LLP, One GOJO Plaza, Suite 300, AKRON, OH, 44311-1076, US

(73) Assignee: INTERNATIONAL MACHINERY LLC, Swansboro, NC (US)

(21) Appl. No.: 12/530,103

(22) PCT Filed: Mar. 5, 2007
(86) PCT No.: PCT/US2007/063297

§ 371 Date: Sep. 4, 2009

(51) Int. Cl. B28D 1/32

(52) U.S. Cl. 125/23.01

(57) ABSTRACT

A stone cutter 10 for quickly and efficiently producing stone cuts and shapes is provided. The stone cutter 10 utilizes a hydraulic cylinder 44 to force a pair of dies 18, 19 about a stone work piece. Each die includes a corresponding ridge 50 extending from the die face to form a peak or cutting edge 52. The force applied to the work piece is transmitted across the work piece at the cutting edges 52, thereby causing the stone work piece to fracture across the transmission line.

This is a national stage application of PCT/US2007/063297, filed Mar. 5, 2007, to which this application claims priority to and the benefit of, the disclosure of which is also incorporated herein by reference.

### FIELD OF THE INVENTION

The present invention relates to a stone cutting (or, more precisely stone fracturing) apparatus and method thereof. More specifically, the invention relates to a machine capable of forming stone shapes from a stone work piece.

### BACKGROUND OF THE INVENTION

Various industries use stone sheets or slabs to form a variety or products, such as countertops and tile. Stone, such as limestone, granite, and marble, is generally cut and formed by saws, such as band saws and circular saws. The use of saws to cut stone and stone shapes can be time consuming, as the saw must travel the entire length of the cut. Further, saws have blades that are generally dimensioned to have a cross-sectional length that reduces blade maneuverability around tight corners, making more intricate cuts and designs more difficult, especially without creating more scrap by making additional entry cuts into the adjacent stone and rendering it unusable. Further, when using small stone work pieces, such as those generated as scrap, the use of saws can be difficult, due to the small sizes, and dangerous to maneuver about the saw blade.

One result of forming stone products, is the production of scrap. Even though much of the scrap is large enough to form other products, such as floor or backsplash tile, the scrap goes unused because it is relatively small, and there is no economical, quick and safe means of processing the numerous, smaller scrap pieces. Consequently, much of the otherwise usable stone scrap is discarded, resulting in increased material waste and costs for disposing of the heavy stone.

Consequently, there is a need to provide a stone cutting means that is quicker, easier to use, safer, and reduces the generation of scrap. Further, there is a need to provide a means of cutting stone that is better suited to accept and use small work pieces. Still further, there is a need to provide a means that is capable of quicky forming stone into a variety of shapes and sizes. Finally, it would be desirous to provide a cutting means that generates crisp cut edges on the product and the scrap, so to render the same usable for further processing.

### SUMMARY OF THE INVENTION

In one embodiment, the present invention provides a stone cutting apparatus comprising: a force transmitting member having a force transmitting direction; and, a pair of opposing dies each having a raised ridge, one of the dies being operably attached to the force transmitting member, and each ridge including a cutting edge and a pair of sides extending from the edge, the apparatus providing a stone engaging position for the pair of dies such that when the dies are in the engaging position, each edge is located substantially opposite the other and extends in a plane substantially parallel to the plane in which the other edge extends.

In another embodiment, the present invention provides a stone cutting apparatus comprising: a force transmitting member having a force transmitting direction; and, a pair of opposing dies each having a raised force transmitting ridge, one of the dies being operably attached to the force transmitting member and each ridge including a cutting edge and a pair of sides extending from the edge, the pair of opposing dies being arranged to engage a stone work piece such that the each edge is in a substantially mirrored relation to the other edge.

In yet another embodiment, the present invention provides a method of fracturing stone comprising: providing a force transmitting member having a force transmitting direction; providing a pair of opposing dies each having a raised force transmitting ridge, one of the dies being operably attached to the force transmitting member and each ridge including a edge and a pair of sides extending from the edge; inserting a stone work piece between the pair of dies; placing the edges of the pair of dies in contact with the stone work piece, such that each edge is in a substantially mirrored relation to the other edge about the stone work piece; and transmitting a force from the force transmitting member to the die operably attached to the member; and fracturing the stone work piece as the force is transmitted from the die to its edge and through the stone to the opposing edge of the opposing die.

### BRIEF DESCRIPTION OF THE DRAWINGS

The present invention may be better understood when making reference to the accompanying drawings, wherein:

FIG. 1 is a right side perspective view the stone cutting press of the present invention;

FIG. 2 is a right side view the stone cutting press shown in FIG. 1;

FIG. 3 is a left side perspective view the stone cutting press shown in FIG. 1;

FIG. 4 is a left side view the stone cutting press shown in FIG. 1;

FIG. 5 is a top view the stone cutting press shown in FIG. 1;

FIG. 6 is a front view the stone cutting press shown in FIG. 1;

FIG. 7 is a cross-sectional view of a die of the stone cutting press shown in FIG. 1;

FIG. 8 is a cross-sectional view of a pair of dies engaging a stone work piece;

FIG. 9 is a top view of an alternative embodiment of the bottom die of the stone cutting press shown in FIG. 1;

FIG. 10 is a top view of an alternative embodiment of the bottom die of the stone cutting press shown in FIG. 1;

FIG. 11 is a cross-sectional view a first embodiment of a die cutting ridge of the press shown in FIG. 1;

FIG. 12 is a cross-sectional view a second embodiment of a die cutting ridge of the press shown in FIG. 1; and,

FIG. 13 is a cross-sectional view a third embodiment of a die cutting ridge of the press shown in FIG. 1.

### DETAILED DESCRIPTION OF THE DRAWINGS

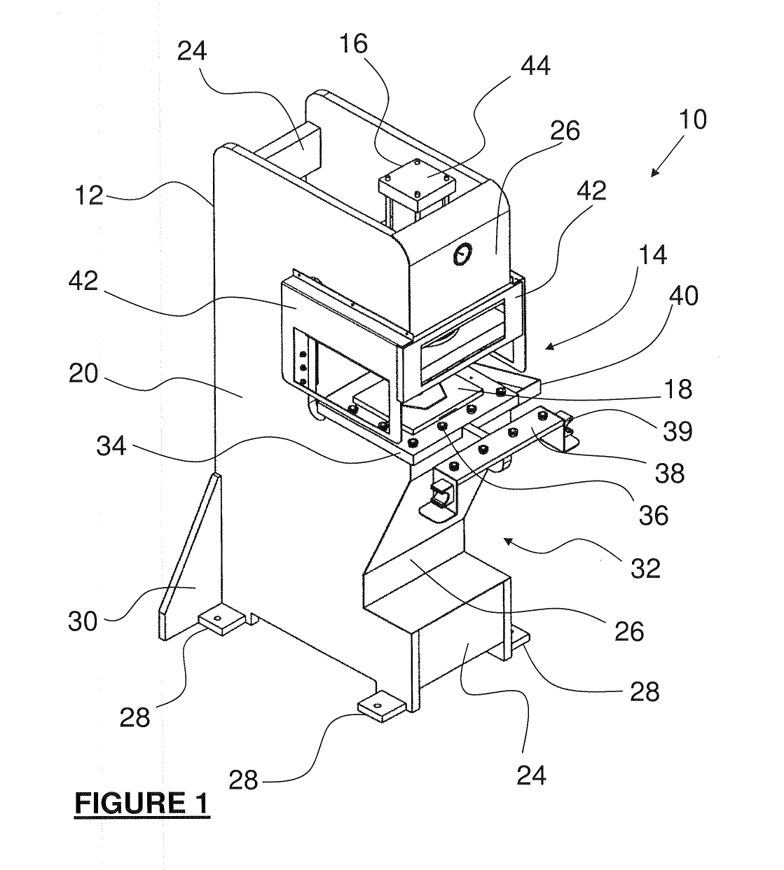

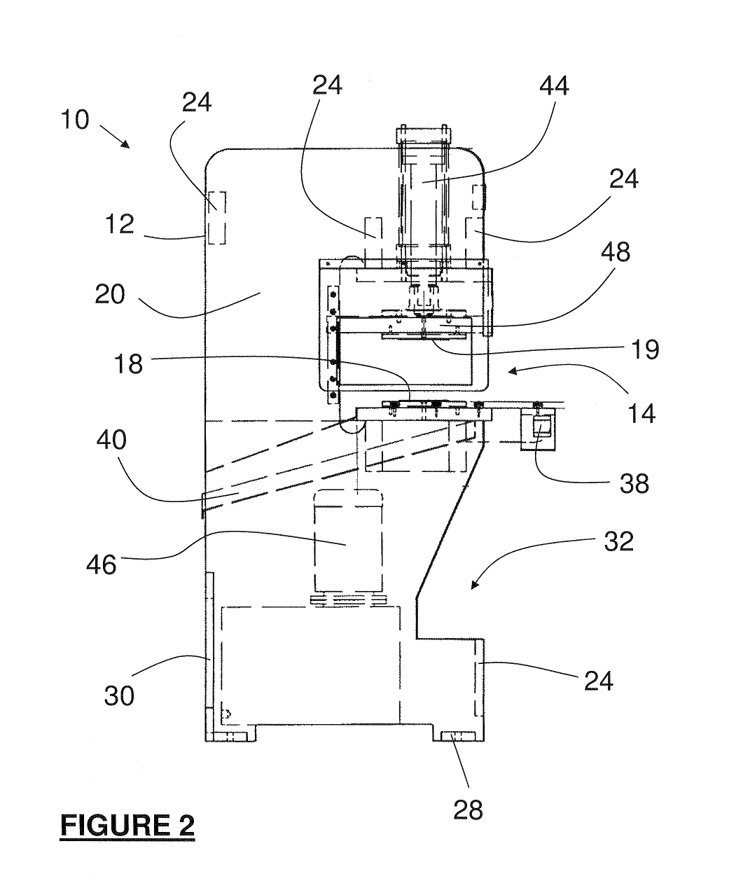

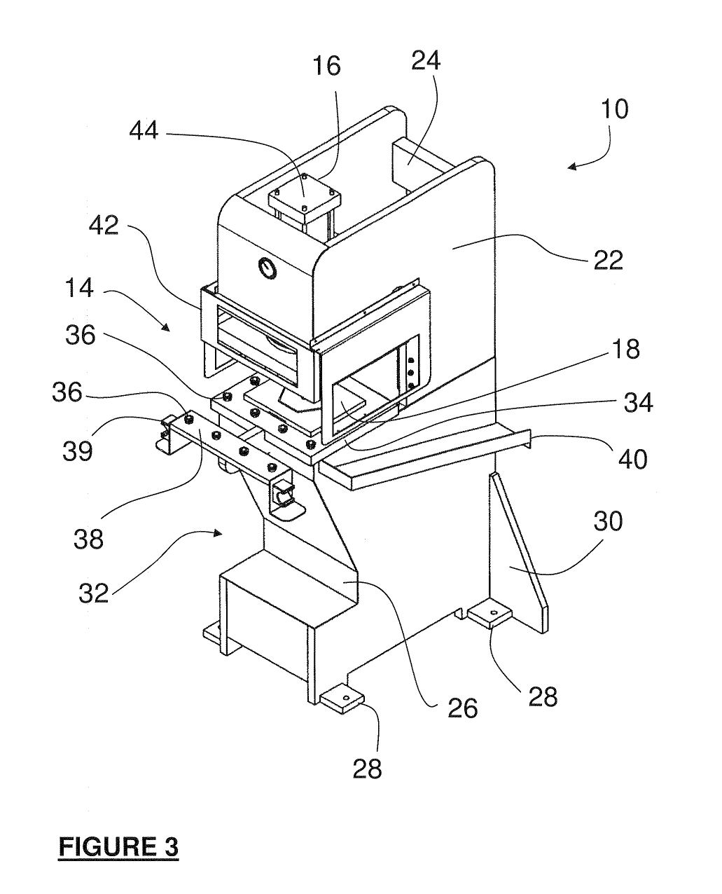

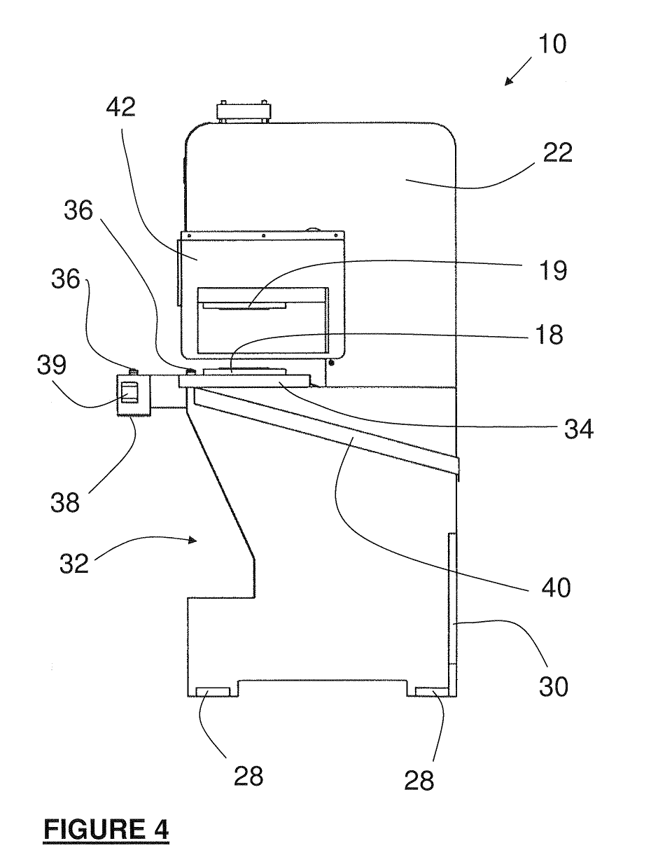

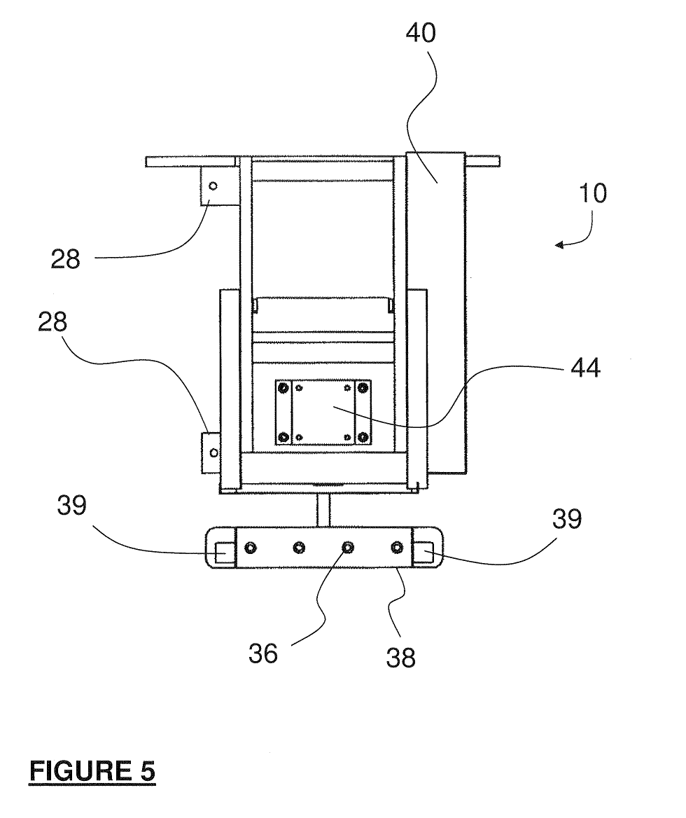

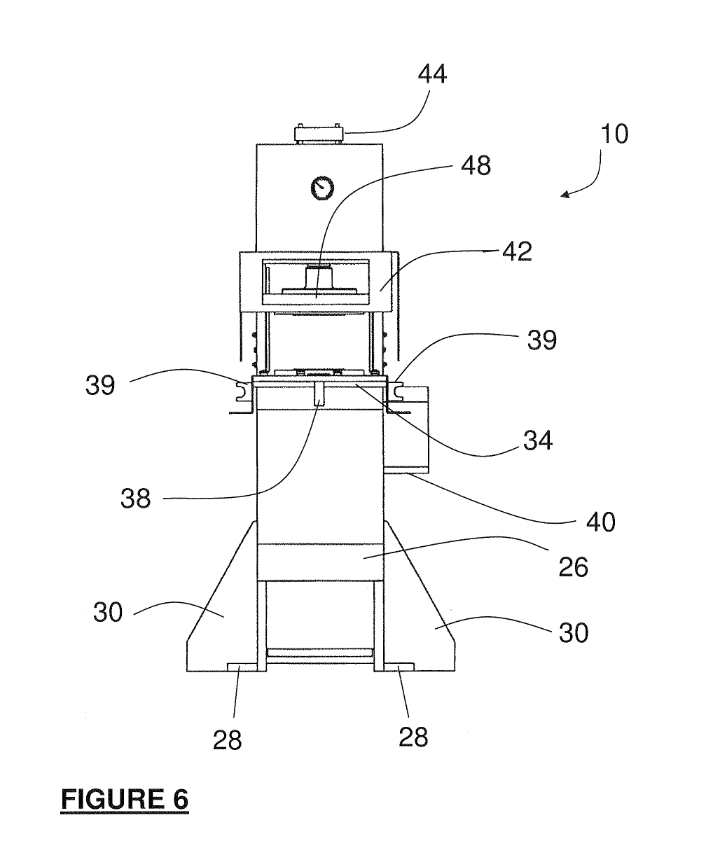

Referring to FIGS. 1-6, the present invention includes a stone cutting press 10. The cutter 10 comprises a housing 12, a processing area 14, a drive unit 16, and a pair of dies 18, 19. “Cut” or “cutting,” as used herein, refers more specifically to the controlled fracturing of stone in a desired shape. “Shape,” as used herein, may be an open shape, such as a line or a curve, or a closed shape, such as a circle, a hexagon, or any other arbitrary closed shape.

Housing 12 provides the structural framework for storing and mounting the components of cutter 10, and for withstanding the cutting loads and the weight of the stone work piece. Housing 12 may be formed in any manner from any material to provide a structural framework for cutter 10. In one embodiment, housing 12 is a “C” frame and comprises a pair of sides 20, 22 made from approximately 1¼ inches thick carbon steel plate with cross-members 24 extending therebetween to prevent buckling under a maximum load from the drive unit 16. It is contemplated that housing 12 may comprise any design, and use any material in any size or form (i.e., plate, I-beams, etc.), provided the design and members provide the strength, rigidity, and durability to withstand the force generated by the drive unit 16, which may vary depending with size and material of the work piece and the length or perimeter of the cut. A cover 26 may be provided across the front, back, and top portions of housing 12 to improve safety, prevent/limit material and dust from entering the housing 12, and/or improve aesthetics. The bottom of housing 12 generally engages the ground and may include any commercially known means for securing the cutter 10 to the ground. In one embodiment, anchor plates 28 utilize bolts or other fasteners to secure cutter 10 to the ground. Further, the bottom of housing 12 may include gussets or outriggers 30 to provide cutter 10 with improved stability (preventing the cutter 10 from tipping front-to-back or side-to-side), and to provide housing 12 with improved strength. A recess 32 along the front of housing 12 and below processing area 14 may be provided to allow a user to gain closer access to the processing unit, and to reduce the weight of the machine.

Processing area 14 generally provides an area for stone to be cut and otherwise processed. Stone generally enters and exists the processing area 14 from the sides and front of the machine. Processing area 14 generally includes a deck 34. Deck 34 generally supports the lower die 18 and any stone placed within cutter 10. A plurality of rollers 36 may be located atop deck 34 to support the stone work piece and better facilitate the translation thereof. Shock absorbers for absorbing forces and vibrations generated during the cutting process may also be included within processing area 14 or otherwise within housing 12. Deck 34 may remain entirely within the processing area 14, or may extend there from to form a larger, extended surface for supporting larger stone work pieces. Further, an extension 38 may extend from processing area 14. Extension 38 may provide controls for operating cutter 10, and may also provide additional surface area for supporting larger stone work pieces. Extension 38 may also include rollers 36 for supporting and translating stone work pieces. A discharge chute 40 may extend from processing area 14, along one or both sides 20, 22 for expelling any waste or product from processing area 14. In one embodiment, chute 40 extends downwardly from the processing area 14 toward the back of cutter 10. Safety shields and windows (collectively “guards”) 42 may extend about the processing area 14 to better isolate the processing area 14 and protect the surrounding area and end-user. In one embodiment, the guards 42 automatically move between an open position and a closed position with cylinder engagement and disengagement.

Drive unit 16 generally provides a driving force for cutting the stone work pieces. In one embodiment, the driving force is generated from a hydraulic cylinder 44, although other sources are contemplated, such as pneumatic cylinder and a shock generating device. Hydraulic cylinders generally operate in conjunction with a hydraulic pump. A hydraulic pump (with motor) 46 may be internal to the cutter 10, or may be located remotely from cutter 10. In one embodiment, cylinder 44 is mounted above processing area 14 to provide a downward stroke of force (the force transmitting direction), that ultimately provides a substantially uniform load across each of the cutting edges 52 of dies 18, 19. The cylinder stroke may be substantially perpendicular to the top die 19, the bottom die 18, and/or the deck 34. In one embodiment, a platen 48 is attached to the extending end of cylinder 44 to facilitate the interchangeability of die 19. Travel of the platen 48 in conjunction with the stroke of the cylinder may be guided, such as by adjustable ribs or shafts. In an alternative embodiment, it is contemplated that platen 48 is driven by four (4) rods extending downwardly from the cylinder, where the rods guide6 platen during each stroke.

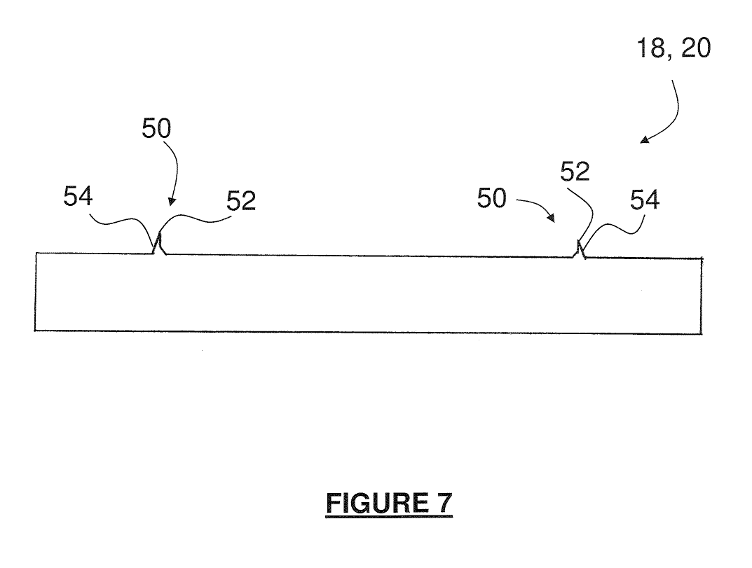

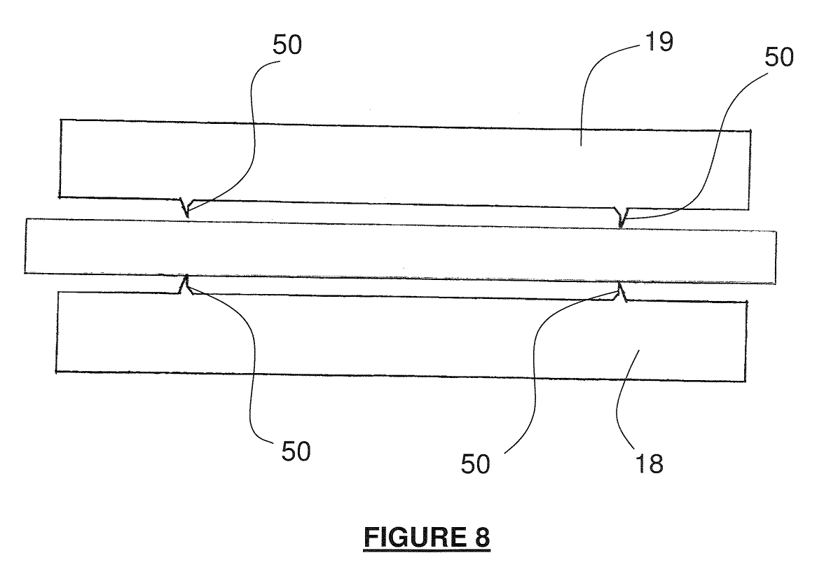

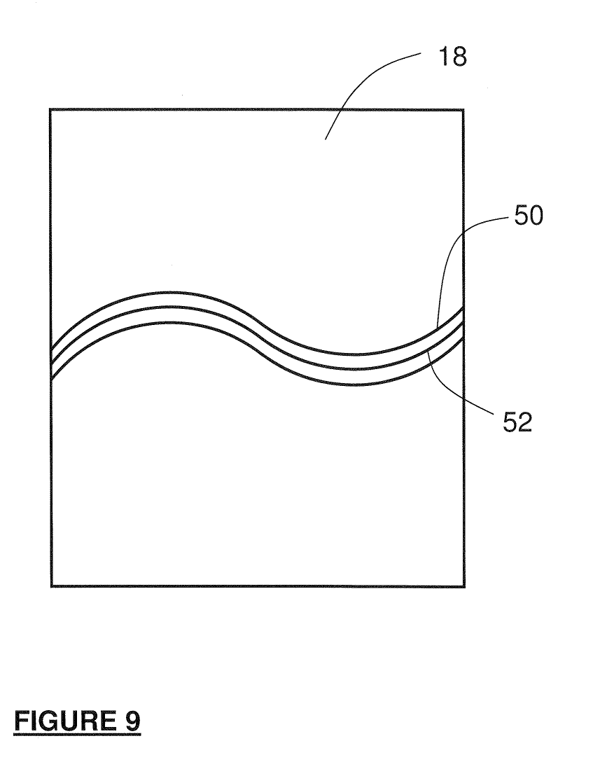

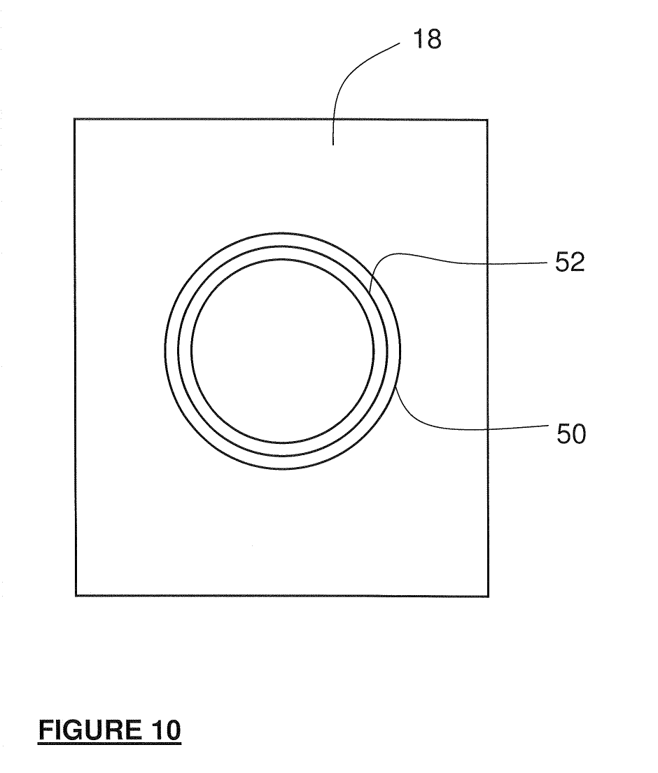

Referring to FIGS. 7-13, stone products are cut (as stated earlier, fractured) by a pair of opposing dies 18, 19. More specifically, each die 18, 19 includes an extending ridge 50 that forms a peak or cutting edge 52. Edge 52 generally extends in a plane. By placing the cutting edges 52 directly opposite each other on the stone work piece, as shown in FIG. 8, fracture forces are directed from the cylinder 44 and between the opposing edges 52. Consequently, fracture stresses are achieved in the stone and the stone fractures along a line between the edges 52. If the edges 52 are not placed opposite each other, the stone will require additional force to achieve fracture, and, more importantly, the fracture edge will not be clean and crisp, but rather be jagged, rough, and even errant or inaccurate. Edges 52, and consequently ridges 50, may form any open shape, such as for example a line or a curve (see FIG. 9), or closed shape, such as for example a circle, triangle, square, rectangle, or an arbitrary shape (see FIG. 10). Dies 18, 19 may be made of any material, such as tool steel, capable of withstanding the high forces generated by drive unit 16, which includes providing relatively good brittleness properties to withstand the compressive loads. In one embodiment, dies 18, 19 are formed of D-2 high carbon, high chrome tool steel. Further, the tool steel may be hardened and tempered to provide a Rockwell hardness in the C scale approximately between 55 to 60 HRC.

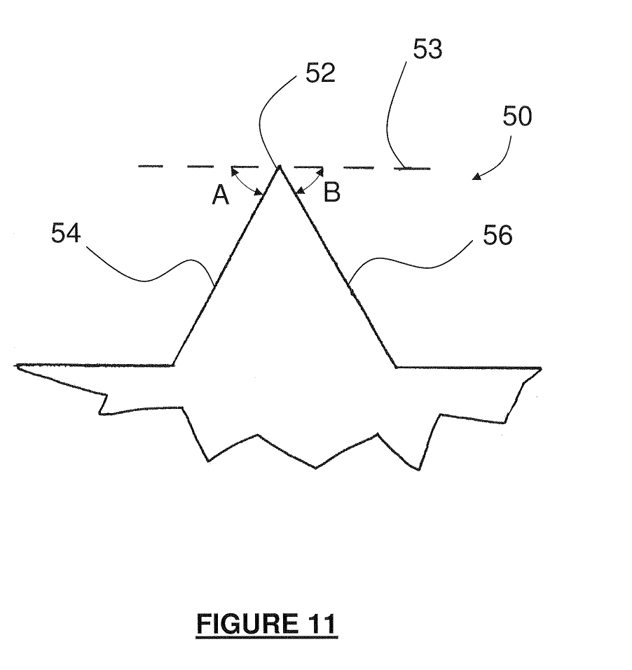

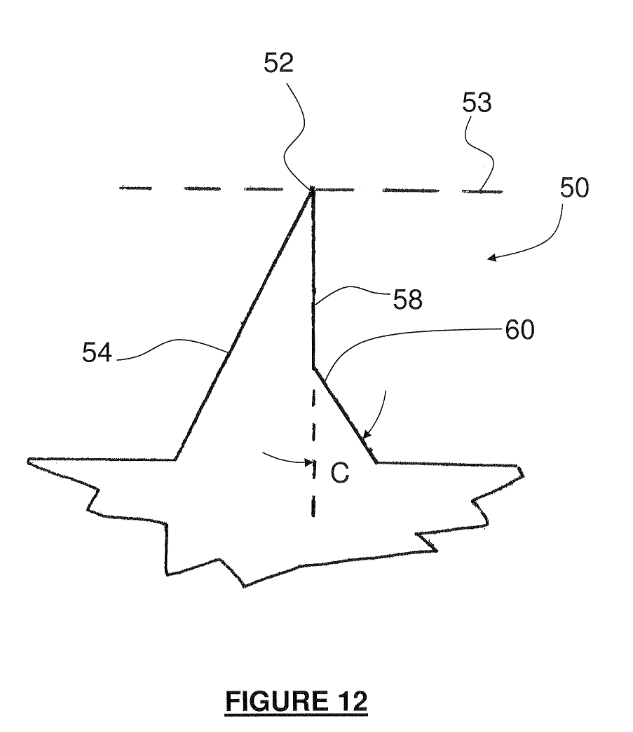

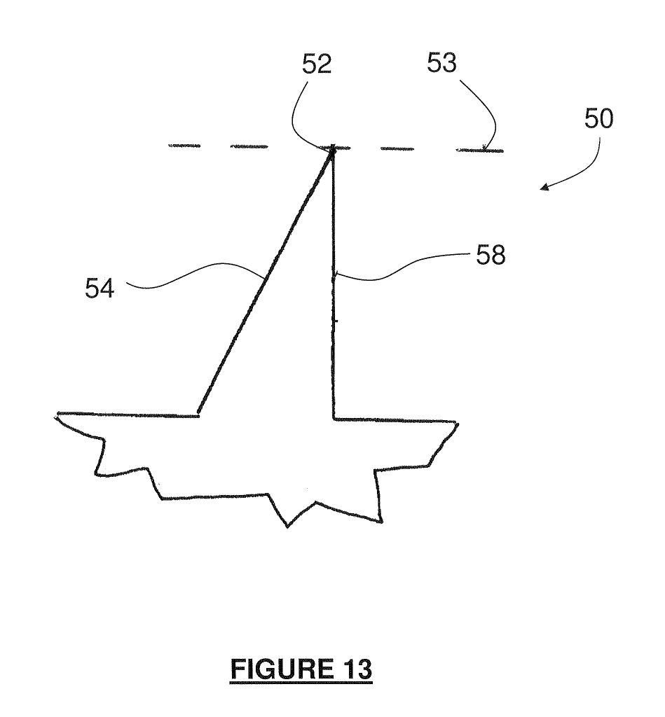

Referring to FIGS. 11-13, each ridge 50 extends from a die and comprises a plurality of surfaces that converge to form a peak or cutting edge 52. In one embodiment, as shown in FIG. 11, the ridge 50 comprises a pair of surfaces 54, 56 extending from the cutting edge 52 at angles A and B. If the die surface from which ridge 50 extends is parallel to the plane 53 in which edge 52 extends, then surfaces 54, 56 may also extend from the die at angles A and B. Ridge 50 may be symmetric or asymmetric about a vertical plane extending through cutting edge 52, or, in other words, angle A may be equal to or different than angle B. In one embodiment, angles A and B are approximately 60 degrees. To provide a cleaner cut edge, angles A and B may be approximately 70 degrees. It is contemplated that angles A and B may be any angle, including any angle equal or greater than 60 degrees. To provide an even cleaner cut edge, a vertical surface 58 (which extends approximately 90 degrees from plane 53) may extend downwardly from the cutting edge 52 on one side of the ridge 50. This vertical surface 58 may extend continuously between the cutting edge 52 and the die, as shown in FIG. 13, or may extend between the cutting edge 52 and a secondary angled surface 60, as shown in FIG. 12. Secondary surface 60 may extend from vertical surface 58 at any angle C, including without limitation 45 degrees. In one embodiment, the cutting edge 52 is no more than 1/32 inches (0.07938 centimeters) wide. Wider or narrower edges 52 may be used; however, if wider, additional force may be required to cut the stone and the cut stone may experience rougher edges. Ridge 50 may extend outwardly from a die at any desired length. In one embodiment, ridge 50 extends approximately ⅜ inches (0.9525 centimeters) outwardly from a die, although it is contemplated that the ridge height may be as low as 3/16 inches (0.4763 centimeters) and greater than ⅜ inches (0.9525 centimeters).

Dies 18, 19 are located in vertical relationship to each other. Upper die 19 may be mounted to platen 48 of cylinder 44, and a lower die 18 may be mounted to deck 34. Dies 18, 19 are arranged so that the cutting edges 52 of each die are vertically opposite each other on either side of the stone piece. In other words, cutting edges 52 of each die 18, 19 mirror each other along a plane that is parallel to, and centrally located between, the planes containing each cutting edge 52. By having the cutting edges 52 directly opposite each other, the distance between the opposing edges 52 is minimized, which maximizes the compressive forces and fracture stress in the work piece. This provides a more efficient process, and a quicker and cleaner cut. In the alternative, it is contemplated that a mating pair of male and female dies 18, 19 may be used to form stone cut-out products. In one embodiment, bottom die 18 is placed on deck 34 via pins, and the top die 19 is hung from platen 48 with dove tails and secured with a screw or screws to ensure that dies 18, 19 are properly aligned. It is contemplated that any other means may be used to mount and secure dies 18, 19.

The amount of force required to cut stone generally depends on the type of stone and its thickness. Generally, darker the stone is higher in density and hardness, and therefore, is more difficult to cut than lighter stone. Therefore, black stone is one of the most difficult stones to cut. By way of example, approximately 22 tons (approximately 19,960 kilograms) of force is required to cut a 3 centimeter (1.181″) slab of black granite material into a hexagon having 4-inch (10.16 centimeter) long sides, or a cut perimeter/contact length of 24 inches (60.96 centimeters). With regard to lighter colors, the required force is reduced to approximately 10 to 14 tons (approximately 9072 to 12,700 kilograms), while marble generally requires 7.5 to 10 tons (6804 to 9072 kilograms). Although stone slabs may be of any thickness, the thickest stone slabs generally sold within the counter industry are approximately 1¼ inches thick (or 1⅜ inches nominally thick). In one embodiment, cutter 10 is designed to cut approximately 1¼ inch black stone. To achieve this, a 5-inch (12.7 centimeter) bore hydraulic cylinder is used. With a system comprising a 6 GPM pump and a 7.5 HP electric motor, and powered by 220 or 440 volts AC, 3-phase source, the cylinder produces 27 tons (24,490 kilograms) of force. If more or less difficult stone is to be cut, i.e., thicker and/or tougher material, a higher force drive system (cylinder) may be desirable. Conversely, if less difficult stone is to be cut, i.e., thinner and/or less tough material, a lower force drive system (cylinder) may be desirable. It is contemplated that press 10 may be capable of cutting any thickness and density of stone, including without limitation gypsum, concrete, brick, marble, granite, soapstone, flagstone, bluestone, limestone, onyx, engineered stone and quartz.

Cutter 10 may be operated manually, where an operator manually opens and closes a valve to operate the cylinder. It is contemplated that the valve may be self-centering, meaning that the valve will return to a stop position when released. Further, cutter may include various controls to more conveniently operate cutter 10, which may be conveniently located for the operator. Such controls may include a pair of palm switches 39 located on extension 38. A hydraulic pressure gauge and mechanical stroke counter may also be conveniently located for the operator. In one embodiment, an operator places his or her hands into the palm activation switches 39, causing the cylinder to operate in rapid closure mode until reaching a predetermined distance, such as ¼ inches above the stone surface. Upon reaching the predetermined distance, platen contacts a slow-down switch, which automatically changes the closing speed to a slower rate. When the work piece is fully cut, an open mode switch is triggered, causing the cylinder to fully retract and stop in an open position. In one embodiment, the operator may not remove his or her hands from the palm switches 39 during rapid closure mode, without causing cutter 10 to automatically switch to open mode. When in slow-down mode, however, the operator may remove his or her hands without affecting the operating mode. The location of all switches along the stroke of the cylinder may be manually controlled and set prior to operation. It is contemplated that cutter 10 may include hand and/or peddle controls in addition to or in lieu of the palm switches, which may manually control the opening and closing of cylinder 44.

The foregoing is an illustration of the invention, which is described with respect to specified embodiments, and is not intended as a limitation. Consequently, other modifications or variations to the specific apparatuses and methods described will be apparent to those skilled in the art and will fall within the spirit of the invention and the scope of the following claims.

I claim:

1. A stone cutting apparatus comprising:
a force transmitting member having a force transmitting direction; and,
a pair of opposing dies each having a raised ridge, one of the dies being operably attached to the force transmitting member, and each ridge including a cutting edge and a pair of sides extending from the edge,
the apparatus providing a stone engaging position for the pair of dies such that when the dies are in the engaging position, each edge is located substantially opposite the other and extends in a plane substantially parallel to the plane in which the other edge extends.

2. The stone cutting apparatus as recited in claim 1, the parallel edge-extending planes being substantially perpendicular the force transmitting direction of the force transmitting member.

3. The stone cutting apparatus as recited in claim 1, the edge of each die extending to form a shape.

4. The stone cutting apparatus as recited in claim 3, the edge of each die extending to form a closed shape.

5. The stone cutting apparatus as recited in claim 1, each side extending from the edge at an angle substantially equal to or greater than 60 degrees relative to a plane substantially perpendicular to the force transmitting direction.

6. The stone cutting apparatus as recited in claim 5, each side extending from the edge at an angle substantially equal to or greater than 70 degrees relative to a plane substantially perpendicular to the force transmitting direction.

7. The stone cutting apparatus as recited in claim 1, one of the pair of sides including a first surface extending from the edge and a second surface extending from the first surface, the first surface extending at an angle greater than the second surface relative to a plane substantially perpendicular to the force transmitting direction.

8. The stone cutting apparatus as recited in claim 7, the first surface extending from the edge at an angle substantially equal to or greater than 60 degrees relative to a plane substantially perpendicular to the force transmitting direction.

9. The stone cutting apparatus as recited in claim 8, the first surface extending from the edge at an angle of approximately 90 degrees relative to a plane substantially perpendicular to the force transmitting direction.

10. The stone cutting apparatus as recited in claim 7, the second surface extending from the first surface at an angle of less than 90 degrees relative to a plane substantially perpendicular to the force transmitting direction.

11. The stone cutting apparatus as recited in claim 1, the force transmitting member being a hydraulic cylinder.

12. A stone cutting apparatus comprising:
a force transmitting member having a force transmitting direction; and,
a pair of opposing dies each having a raised force transmitting ridge, one of the dies being operably attached to the force transmitting member and each ridge including a cutting edge and a pair of sides extending from the edge,
the pair of opposing dies being arranged to engage a stone work piece such that the each edge is in a substantially mirrored relation to the other edge.

13. The stone cutting apparatus as recited in claim 12, the die operably attached to the force transmitting member being arranged to engage the stone work piece where the edge of such die extends in a plane substantially perpendicular to the force transmitting direction.

14. The stone cutting apparatus as recited in claim 12, the edge of each die extending to form a shape.

15. The stone cutting apparatus as recited in claim 12, each side extending from the edge at an angle substantially equal to or greater than 60 degrees relative to a plane substantially perpendicular to the force transmitting direction.

16. The stone cutting apparatus as recited in claim 15, each side extending from the edge at an angle substantially equal to or greater than 70 degrees relative to a plane substantially perpendicular to the force transmitting direction.

17. The stone cutting apparatus as recited in claim 15, one of the pair of sides including a first surface extending from the edge and a second surface extending from the first surface, the first surface extending at an angle greater than the second surface relative to a plane substantially perpendicular to the force transmitting direction.

18. A method of fracturing stone comprising:
providing a force transmitting member having a force transmitting direction;
providing a pair of opposing dies each having a raised ridge, one of the dies being operably attached to the force transmitting member and each ridge including a cutting edge and a pair of sides extending from the edge;
inserting a stone work piece between the pair of dies;
placing the edges of the pair of dies in contact with the stone work piece, such that each edge is in a substantially mirrored relation to the other edge about the stone work piece; and
transmitting a force from the force transmitting member to the die operably attached to the member; and
fracturing the stone work piece as the force is transmitted from the die to its edge and through the stone to the opposing edge of the opposing die.

19. The method as recited in claim 18, the die operably attached to the force transmitting member being arranged to engage the stone work piece where the edge of such die extends in a plane substantially perpendicular to the force transmitting direction.

20. The stone fracturing apparatus as recited in claim 18, the edge of each die extending to form a shape.

21. The method as recited in claim 18, each side extending from the edge at an angle substantially equal to or greater than 60 degrees relative to a plane substantially perpendicular to the force transmitting direction.

22. The method as recited in claim 21, each side extending from the edge at an angle substantially equal to or greater than 70 degrees relative to a plane substantially perpendicular to the force transmitting direction.

23. The method as recited in claim 21, one of the pair of sides including a first surface extending from the edge and a second surface extending from the first surface, the first surface extending at an angle greater than the second surface relative to a plane substantially perpendicular to the force transmitting direction.

24. The method as recited in claim 18, the force transmitting member being a hydraulic cylinder.
